(19) United States
(12) Patent Application Publication
(10) Pub. No.: US 2013/0179569 A1
(43) Pub. Date: Jul. 11, 2013

(54) SYSTEMS AND METHODS FOR GATEWAY STATUS INFORMATION HANDLING

(71) Applicant: James Harris Alred, Indianapolis, IN (US)

(72) Inventor: James Harris Alred, Indianapolis, IN (US)

(73) Assignee: THOMSON LICENSING, Issy de Moulineaux (FR)

(21) Appl. No.: 13/825,630

(22) PCT Filed: Oct. 6, 2010
(86) PCT No.: PCT/US10/02698

§ 371 Date: Mar. 22, 2013

(51) Int. Cl. H04L 12/26

(52) U.S. Cl. CPC H04L 43/10
USPC 709/224

(57) ABSTRACT

A gateway information system employs redirecting of a browser connected through a gateway to a page on the gateway which gives details of important gateway exceptions. In other instances, the gateway information is only generated and displayed for certain users, allowing transparent gateway access to other users Administrators of a network can be automatically directed to the gateway generated page and only when there are significant exceptions that need to be addressed.

### BACKGROUND

Many computer networks connect to other networks through a point called a “gateway.” In a home environment, a network can be set up with various computing devices, printers, cell phones, etc. These devices typically go through a common point or gateway to reach an external network such as the Internet. Most gateway devices can have status indicators that relay simple conditions to a user who monitors the device. To allow more complete status information, the gateway can be controlled through a networked computer usually via a hyper-text markup language (html) generated web page. Unfortunately, most gateway users are not diligent enough to navigate to the gateway's web pages, read and sort through the errors and warnings in the logs. Unless the gateway user does this, it is almost impossible to convey anything but the most basic status (e.g., through the use of LED's on the device). Thus, important information is sometimes missed because the gateway user rarely, if ever, takes the time or remembers to read the status logs.

### SUMMARY

A browser of a user connected through a gateway is redirected to a page on the gateway which gives details of important gateway exceptions. In this manner, gateway information is brought to the user's attention easily and without extra effort by the user. The errors and warnings logged by the gateway are kept in memory on the device and, in some instances, can be filtered to provide the user with the most important information from these logs automatically. In other instances, the gateway information is only generated and displayed for certain users, allowing transparent gateway access to other users. For example, administrators of a network can be automatically directed to a gateway-generated page and only when there are significant exceptions that need to be addressed.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is a block diagram of a gateway information system in accordance with an aspect of an embodiment.

FIG. 2 is another block diagram of a gateway information system in accordance with an aspect of an embodiment.

FIG. 3 is a flow diagram of a method of handling gateway status information in accordance with an aspect of an embodiment.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

A gateway's log files can be automatically filtered and important status information can be disseminated, for example, as a page in the gateway user's web browser. A web page can be generated depicting the important status information and shown to a user by redirecting the user's web browser to that page when the user employs the gateway to access the Internet. The generated web page can have a control for the user to continue on to the web page they intended to navigate to. Thus, important status information that was previously only available by browsing the gateway's web pages is automatically presented to a user in a convenient way when the user uses the gateway. Refinements can be augmented to present the important status web pages only to specified users, thereby reducing the number of interruptions to users who are not interested in them.

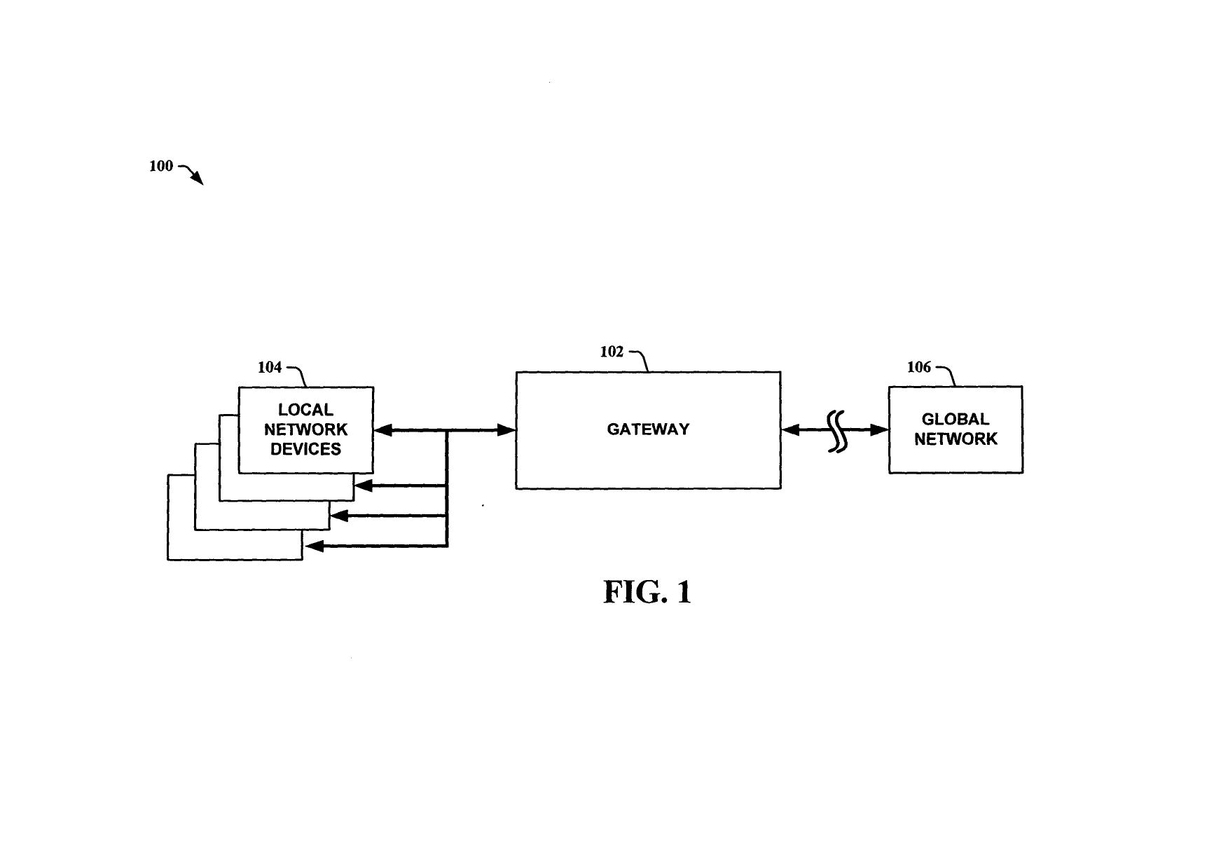

FIG. 1 shows a block diagram of a gateway information system 100 that utilizes a gateway 102 to interface between local network devices 104 and a global network 106. The local network devices 104 can include, but are not limited to, computers, printers, cell phones, televisions, digital video disc (DVD) players, etc. that can be connected to a network. The local network devices 104 can also include a single computing device. For example, a home network can include multiple computers, wireless cell phones and an entertainment device such as a DVD player. These can be connected, directly or indirectly, to a network through gateway 102. In another example, in a business environment, the local network devices 104 can include tens or even hundreds of computers, fax machines, copiers, printers, servers, etc. Whether in a home or business the local network devices 104 typically desire to access the global network 106 at some point. The global network 106 can include, for example, the Internet and the like. The gateway 102 provides access to the global network 106 for the local network devices 104. The local network devices 104 can be interlinked by an intranet that then uses the gateway 102 to access the global network 106.

Since the gateway 102 has knowledge of the outgoing network traffic and knowledge of the local network devices 104, it can determine when and from what device the global network is accessed. This knowledge permits the gateway 102 to regulate gateway status information dissemination based on timing and user. Communication between the gateway 102 and the local network devices already exists for the network connections, thus, the gateway 102 can leverage the same connections to communicate its status information to the local network devices 104. Criteria for selecting a particular local network device for information display by the gateway 102 can be based on the technical specifications of the local network devices 104 (e.g., some devices might not have display capability such as, for example, a fax machine, etc.), prior selection by a network administrator, and/or based upon a particular user of a local network device (e.g., administrator logged into a computer terminal, etc.).

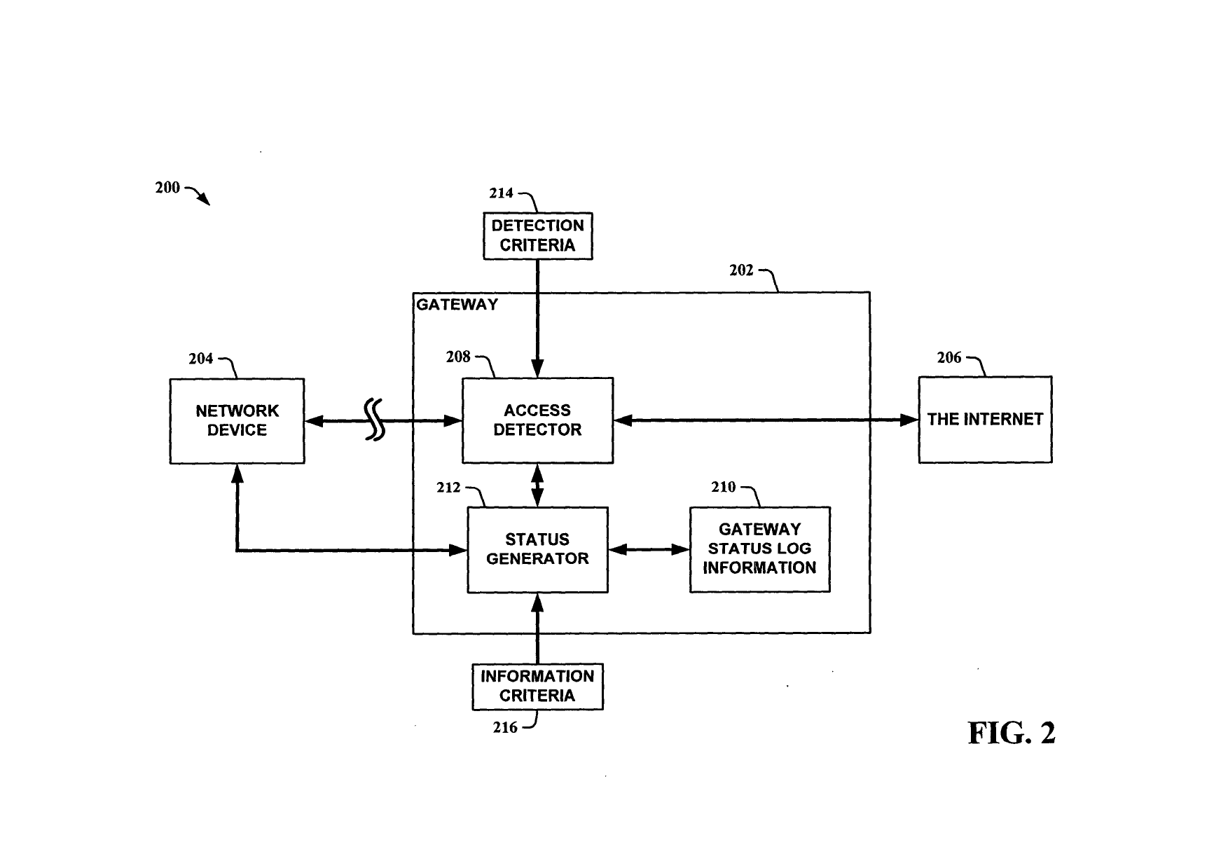

Looking at FIG. 2, another example of a gateway information system 200. The gateway information system 200 utilizes a gateway 202 connected to a network device 204 and the Internet 206. In this example, the network device 204 uses the gateway 202 to connect to the Internet 206. Thus, the gateway 202 has knowledge of by whom and when the Internet 206 is accessed. Since the network device 204 typically accesses the Internet 206 through a web browser, it is also possible for the gateway 202 to know what user is currently using the network device 204.

In this manner, the access detector 208 can detect when the network device 204 requests access to the Internet 206 and, optionally, which user is requesting the access. Detection criteria 214 for the detector can come from default parameters (e.g., first computing device always receives gateway status information or first access request of the day receives gateway status information, etc.) and/or selected parameters from an administrator or other user and the like (e.g., from a given network profile, etc.). When the access detector 208 determines that the contact criteria are met, it informs a status generator 212. The status generator 212 provides the gateway status information in a useable format to the network device 204. The useable format can vary depending on what type of network device 204 the information is being sent to. Not all network devices have the same capabilities when it comes to relaying information to a user—some may have graphical abilities or only text capabilities. Display sizes can also vary greatly and audible indications may or may not be present as well. Thus, the status generator 212 can take these variables into account when relaying the gateway status information.

A typical gateway generally stores status information locally. In this example, status data is stored in gateway status log information 210. The gateway status log information 210 represents common and emergent information alike. Some of the information can be critical while other information is benign. Oftentimes, the information stored becomes quite large and is difficult for a user to comprehend and very time-consuming to review. The status generator 212 uses information criteria 216 ascertained by default and/or from a user such as, for example, an administrator to determine what events in the gateway status log information are important enough to display to the network device 204 and/or a user. Algorithms can also be employed in filtering the information criteria 216. Thus, the gateway status log information 210 can be dramatically reduced in size and reporting frequency, drastically reducing the notifications and workload of a network administrator and the like. In a typical use scenario, a network administrator could receive “important” notifications each time the network is accessed. This allows automatic displaying of important notifications soon after a critical event occurs. If desired, subsequent Internet accesses can suppress notifications already viewed and/or acknowledged by the administrator. In some cases, the administrator might desire to suppress notification when a status event is below a particular threshold.

The status generator 212 typically utilizes a web browser html page to disseminate the information. This allows formatting and other parameters to be standardized based on browser standards. However, other means of disseminating the information are within the scope of embodiments disclosed herein. This can include, but is not limited to, pop-up browser windows, messenger pop-ups, network status pop-up windows and the like.

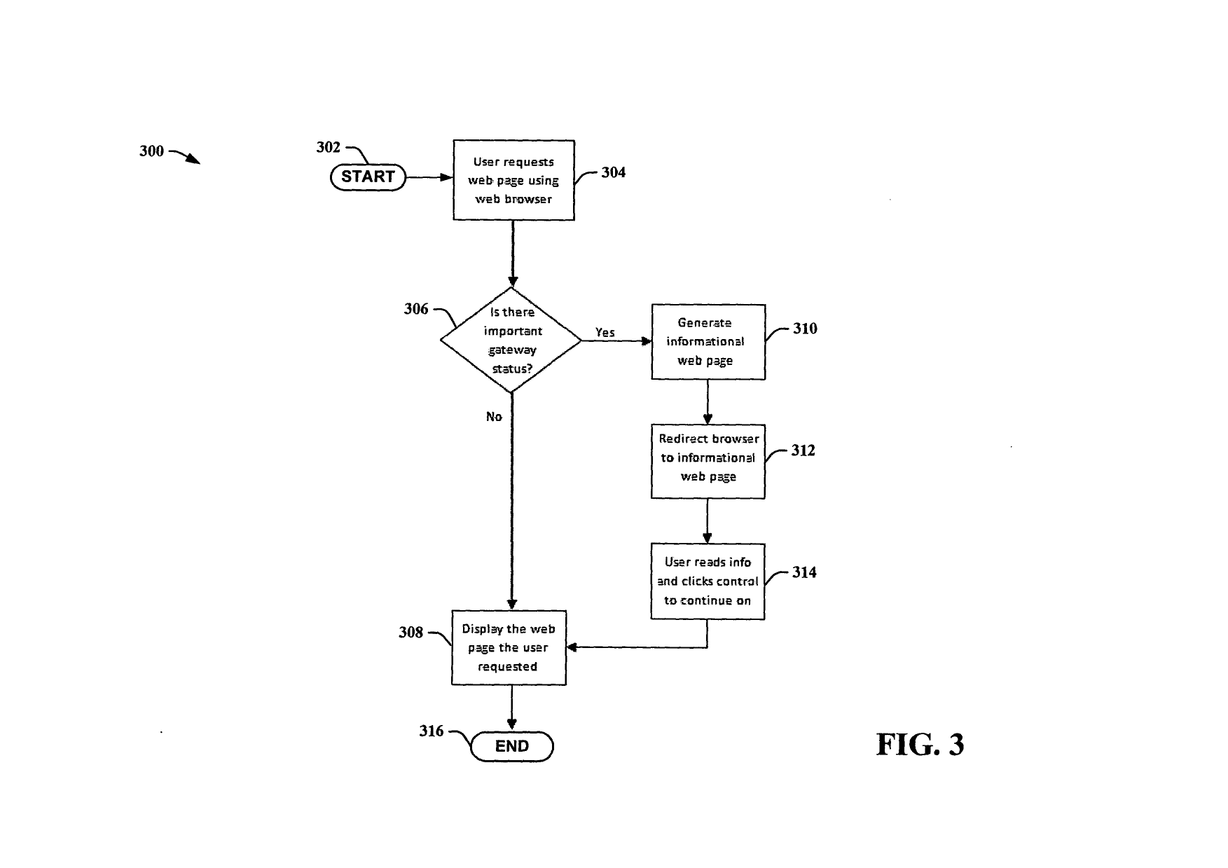

In view of the exemplary systems shown and described above, methodologies that can be implemented in accordance with the embodiments will be better appreciated with reference to the flow chart of FIG. 3. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

In FIG. 3, a flow diagram of a method 300 of handling gateway status information is shown. The method stats 302 when a user requests a web page using a web browser 304. A determination is then made as to whether important gateway status information exists 306. As noted before, the criteria to determine if the status information is important can be provided by default, by a user and/or by an administrator and the like. If no, the web page that the user requested is displayed 308, ending the flow 316. In this instance, the user is shielded from unnecessary status information and their web browsing continues uninterrupted. If, however, important status information is available, an information web page is generated 310. The browser is then redirected to the informational web page 312. The user can then read the status information and has the option of indicating to continue on 314 to their initially requested web page 308, ending the flow 316. This allows dissemination of status data in a productive manner. The user is only automatically interrupted when the status data is of a particular importance, greatly reducing the tedious nature of reviewing status logs to find important status data.

It is to be appreciated that the systems and/or methods of the embodiments can be utilized in gateway facilitating computer components and non-computer related components alike. Further, those skilled in the art will recognize that the systems and/or methods of the embodiments are employable in a vast array of gateway technologies and the like.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A gateway information system, comprising:
an access detector that detects access through a gateway; and
a status generator that generates gateway status information when access has been detected.

2. The system of claim 1, wherein the access detector detects based on criteria provided by at least one of a network device and a network user.

3. The system of claim 2, wherein the criteria includes at least one of a time when to display the status information and to whom to display the status information.

4. The system of claim 1, wherein the status generator generates gateway status information based on criteria provided by at least one of a network device and a network user.

5. The system of claim 4, wherein the criteria includes on what events to generate gateway status information.

6. The system of claim 1, wherein the status generator sends the gateway status information to at least one of a network device and a network user.

7. The system of claim 1, wherein the status generator provides the gateway status information in a browser page.

8. The system of claim 7, wherein the status generator provides a link in the browser page for a user to continue to a requested browser location.

9. A method for providing gateway status information, comprising the steps of
detecting access of a requested browser page through a gateway based on gateway status notification criteria; and
automatically generating a browser page with gateway status information when access has been detected.

10. The method of claim 9, further comprising the step of:
receiving gateway status notification criteria from at least one of a network device and a user.

11. The method of claim 9, further comprising the step of:
filtering the gateway status information based on a level of importance before inclusion into the browser page.

12. The method of claim 9, further comprising the step of:
notifying at least one of a network device and a user of the automatically generated browser page with gateway status information.

13. The method of claim 9, further comprising the step of redirecting access to a requested browser page to the automatically generated gateway status information browser page.

14. The method of claim 9, further comprising the step of:
embedding a requested browser page link in the automatically generated gateway status information page.

15. A system, comprising:
means for detecting access of a requested browser page through a gateway based on gateway status notification criteria; and
means for automatically generating a browser page with gateway status information when access has been detected.

16. The system of claim 15, further comprising:
means for filtering the gateway status information based on a level of importance before inclusion into the browser page.

17. The method of claim 15, further comprising:
means for notifying at least one of a network device and a user of the automatically generated browser page with gateway status information.
